(19) United States
(12) Patent Application Publication
(10) Pub. No.: US 2004/0139475 A1
(43) Pub. Date: Jul. 15, 2004

(54) Broadcast enhancement database replication

(76) Inventor: Ian Zenoni, Highlands Ranch, CO (US)

Correspondence Address: The Law Offices of William W. Cochran, LLC, Suite 230, 3555 Stanford Road, Fort Collins, CO, 80525, US

(21) Appl. No.: 10/625,456

(22) Filed: Jul. 22, 2003

Related U.S. Application Data
(60) Provisional application No. 60/400,580, filed on Jul. 22, 2002.

(51) Int. Cl. H04N 7/173; H04N 7/16

(52) U.S. Cl. 725/113; 725/109; 725/110; 725/135; 725/136

(57) ABSTRACT

An enhancement menu including at least one selection associated with a predetermined identifier is provided to a receiving unit. Selection of at least one selection results in the receiving unit monitoring a broadcast and acquiring data associated with the identifier. A data structure is defined for data elements. Software associated with storage and display of the data structure may be transmitted to the receiving unit or may be broadcast to a plurality of receiving units and may be associated with the identifier. Data elements may be transmitted to individual receiving units. Broadcast data elements may provide new data structure entries or may replace existing entries. Data elements may be broadcast at a predetermined interval or in response to a change in the value of the data element. User selection of a displayed data element may provide execution of code associated with the data element, may provide a link, or may result in acquiring of data using a new identifier. A broadcast schedule is formulated reflecting enhancement data types. A transmission schedule may be formulated using user requests.

### CROSS REFERENCE TO RELATED APPLICATIONS

This application claims benefit of U.S. provisional patent application No. 60/400,580 entitled “BROADCAST ENHANCEMENT DATABASE REPLICATION”, filed Jul. 22, 2002 by Ian Zenoni which is specifically incorporated herein by reference for all that it discloses and teaches.

### BACKGROUND OF THE INVENTION

a. Field of the Invention

The invention pertains to the transfer of information across a network such as the Internet or television systems providing enhancement information and more specifically to the efficient broadcast of frequently requested information.

b. Description of the Background

Cable television systems typically carry a range of transmissions including analog television, digital television, television enhancements, and Internet data transfers. The bandwidth of the cable system is shared among these various services. A television program may be accompanied by additional information employed to enhance the program. Such enhancements have historically included closed captioning and multilingual support. Advances in networking, computer systems, and video production have increased the number and types of enhancements that may be provided with a program or advertisement. Enhancements may include stock updates, news stories, Internet links, weather forecasts, bulletins, and other information, for example. Interactive television and enhanced television systems may employ upstream cable data transfers, the Internet, or other network-based communications to request information or enhancements. For example, television viewers may elect to play along with a trivia game show broadcast and as such may submit requests for an “at home” play-along version of the game show to be activated on their receiver. Similarly, viewers of a sports contest, such as a football game, for example, may request that scores from other games be displayed. Such requests are typically sporadic, occurring at the beginning of a program such as a game show, or during a pause in the action of a sporting event, such as review of a play by officials, half time, or presentation of an advertisement, for example. Further, the information associated with such requests may change over time, such as game scores or stock quotes, for example. Such information may comprise a table of data that is presented to the viewer as one or more elements at a time, such as a scrolling display that may appear across the bottom of the screen. As data elements contained within a data table change, such as the change in a team score or update to stock prices, the changes are conveyed to the viewers. Stock prices may be updated at some regular interval, such as once every three minutes, for example, while sports scores may be updated as scores change. The transfer of sports scores and stock values to a plurality of viewers can require considerable bandwidth, especially if individual servicing of requests is performed. Further, often only part of a data table need be updated, such as when sports scores change, for example. In order to update only part of a data table when individual servicing of requests is employed, the system must maintain a list of viewers being serviced and the status of updates. These methods are bandwidth and server intensive. Therefore a new method of serving interactive information requests is needed that allows greater bandwidth efficiency and that allows a network system to support more users, thereby providing increased service and opportunities for increased revenue by supporting a greater number of users.

### SUMMARY OF THE INVENTION

Various embodiments of the present invention overcome the disadvantages and limitations of the prior art by providing a system and method that disseminates data structure elements to receiving units in a broadcast format, eliminating the high bandwidth requirements of individual servicing of requests. Further, depending on the nature of the data elements being provided, a receiving unit may be provided with a database containing initial values, or may simply be configured to “listen” for data elements that are broadcast and to store or update data elements in an internal data structure as data elements are broadcast. Initial values may be transmitted to individual receiving units. A receiving unit may issue a request to an enhanced content provider for data elements contained in one or more data structures. Computer program code corresponding to a requested enhancement may be transmitted to individual receiving units or may be broadcast to a plurality of receiving units using a predetermined identifier. Data elements are stored locally in the receiving unit and may be displayed in response to a user input. A viewer may elect to turn on or turn off enhancements while viewing a program.

The broadcast method of embodiments of the present invention requires much less bandwidth than individual transmission of data elements to individual receiving units. Advantageously, this allows additional services to be provided, allowing greater customer satisfaction and an opportunity for increased revenue.

An embodiment of the present invention may therefore comprise a method of transferring data elements of a data structure to a receiving unit in a broadcast video system comprising: broadcasting enhancement computer program code to a plurality of receiving units including the receiving unit wherein the code defines a data structure within a memory of the receiving units, provides a menu having a plurality of enhancement selections, associates an identifier with at least one enhancement selection of the plurality of enhancement selections, and enables the receiving unit to acquire data using the identifier; accessing a plurality of data elements such that at least one data element corresponds to the at least one enhancement selection; associating the identifier with the at least one data element; broadcasting the at least one data element and the identifier to the plurality of receiving units including the receiving unit; accessing a second data element corresponding to the at least one enhancement; associating the identifier with the second data element; and broadcasting the second data element and the identifier to the plurality of receiving units including the receiving unit.

An embodiment of the present invention may further comprise a method of replicating a portion of a data structure stored in an upstream device of a broadcast system in a receiving unit of the broadcast system and displaying an element of the data structure at the receiving unit comprising: receiving a broadcast at the receiving unit that includes enhancement computer program code that defines at least one data structure and that provides a menu having a plurality of different enhancement selections and that associates an identifier with at least one enhancement selection of the plurality of different enhancement selections and that enables the receiving unit to acquire data associated with the identifier; receiving a user input selecting the at least one enhancement selection from the menu; monitoring a broadcast for the identifier; acquiring a data element associated with the identifier; storing the data element in the data structure in a memory of the receiving unit; and displaying the data element.

An embodiment of the present invention may further comprise a receiving unit that replicates a portion of a broadcast data structure comprising: a CPU; a memory; video hardware that produces an on-screen display of enhancement data elements; and computer program code stored in the memory that defines a data structure and an enhancement menu having at least one enhancement selection associated with an identifier and that monitors a broadcast for the identifier and acquires and stores a data element associated with the identifier in the data structure, and displays the data element, if a user selects the at least one enhancement selection.

An embodiment of the present invention may further comprise a method of replicating a portion of an upstream device data structure in a receiving unit comprising: determining enhancement content to be provided; creating an enhancement broadcast schedule; creating an enhancement menu having a plurality of enhancement selections; associating an identifier with at least one enhancement selection of the plurality of enhancement selections; broadcasting the enhancement menu to a plurality of receivers; accessing a plurality of data elements for the enhancement menu selections; associating the identifier with at least one data element of the plurality of data elements; and broadcasting the at least one data element and the identifier to a plurality of receiving units including the receiving unit.

Advantages of the various embodiments include the ability to provide reduced bandwidth by allowing broadcast enhancements to be sent to a wide audience of viewers, providing request-based enhancements coexistent with broadcast enhancements, use of an identifier to transfer selected data and code to receiving units that permits only the required code to be loaded, reducing receiving unit memory requirements, and hot data elements that provide a link to further enhancements and provide advertising opportunities.

### DESCRIPTION OF THE FIGURES

In the figures,

FIG. 1 is a block diagram depicting a cable television broadcast system.

FIG. 2 shows a display screen depicting the manner in which database elements may be displayed.

FIG. 3 is a flow diagram depicting a receiving unit specific transmission method for servicing enhancement data requests.

FIG. 4 is a flow diagram depicting one method for broadcast database replication.

FIG. 5 is a flow diagram depicting a second method for broadcast database replication.

FIG. 6 is a flow diagram depicting another method for database replication.

FIG. 7 is a flow diagram depicting the steps performed by a receiving unit for one embodiment of broadcast database replication

FIG. 8 is a flow diagram depicting the steps performed by a receiving unit for another method of broadcast database replication.

FIG. 9 is a flow diagram depicting steps performed by a receiving unit for another embodiment of broadcast database replication.

FIG. 10 is a flow diagram depicting steps performed at an upstream device to implement one embodiment of broadcast database replication.

FIG. 11 is a flow diagram is a flow diagram depicting steps performed at an upstream device to implement another embodiment of broadcast database replication.

### DETAILED DESCRIPTION OF THE INVENTION

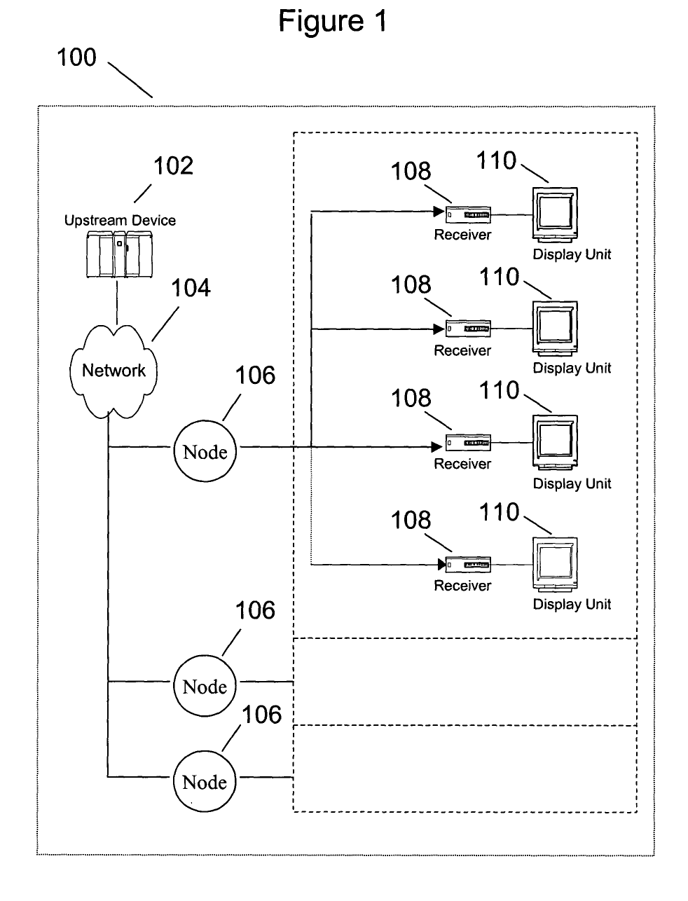

FIG. 1 depicts a cable television broadcast system. Cable system 100 comprises upstream device 102, network 104, nodes 106, receivers 108, and display units 110. Upstream device 102 delivers television programming to the receivers 110, via network 104 and nodes 106. Upstream device 102 may comprise a headend or other distribution system. Upstream device 102 may comprise components from R.L. Drake Company located at 230 Industrial Drive, Franklin Ohio 45005 U.S.A. or components from Cisco Systems Inc., located at 170 West Tasman Dr. San Jose, Calif. 95134 USA. Network 104 may comprise fiber optic, coaxial cable, terrestrial or satellite transmission, or combinations thereof, as is common to the art. The connections from nodes 106 to receivers 108 are frequently coaxial cable but are not limited to a particular material. Receivers 108 convert the incoming programming information into a format appropriate for input to display units 110, and thus for viewing by end users of the system 100. Receivers 108 may comprise set-top boxes, personal computers, interactive televisions, or other equipment operable to process television signals and other information, such as control information and program guides, for example. Display units 110 may comprise televisions, computer monitors, or other devices operable to display video images.

The cable network of FIG. 1 may be employed to broadcast television content, television content enhancements, and may support Internet users. Television programming may employ analog or digital formats or a combination thereof. Television content enhancements may comprise on-screen images, text, graphics and audio. Enhancements have historically included closed captioning and multilingual support. Advances in networking, computer systems, and video production have increased the number and types of enhancements that may be provided with a program or advertisement. Enhancements may include statistics for sporting events, current standings, and may include real-time information, such as the speed of a racecar, for example. For example, a football game may include icons allowing viewing of team players, statistics, trivia and other information such as upcoming games. Set-top-boxes, as are often used in cable and satellite television systems, allows enhancement information to be presented along with a broadcast program, such as screen in overlays and in windows, for example.

Enhancements may be presented as an overlay with a displayed program, or may be displayed in a windowed area of the screen, such as window along the bottom or side of the screen. Computer program code operating in the set top box, interactive television or similar receiving equipment may be downloaded when the receiving unit is powered on or when interactive content is to be presented. The software program may provide a menu of interactive options through which the viewer may navigate and select items via a remote control or other input device. The selection of an interactive television menu item may generate a request that is routed to the broadcaster or enhancement content provider where it is processed. Requests may be associated with displayed content, such as a video program or advertisement, or may be general in nature. For example, a viewer watching a football game may request statistics for the game or may request scores for other games. Alternatively, the viewer may request information not associated with a program, such as a weather forecast, for example. Displayed enhancement items may consist of a list of information from a database, such as a database of team scores.

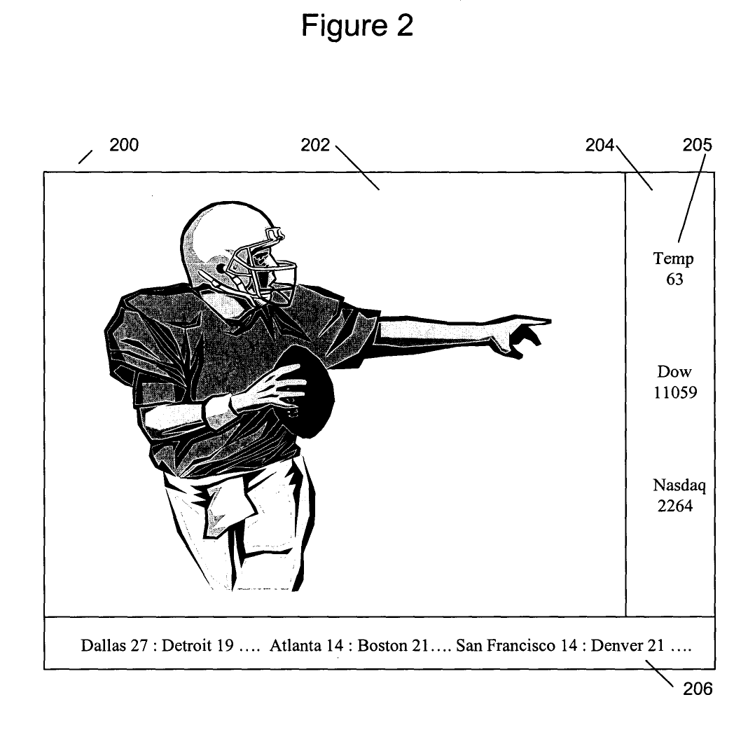

FIG. 2 shows a display screen depicting a manner in which database elements may be displayed. Display screen 200 comprises video program 202, First enhancement data window 204, and second enhancement data window 206. Information may be presented in a fixed location, such as temperature 205 in first data window 204, or may be scrolled across the screen as may be performed for team scores as depicted in second data window 206. Alternatively, a sequence of different team scores may be presented in a fixed location and the location me be selected or may be adjusted by a viewer. FIG. 2 serves to illustrate how enhancement may be presented however the present invention is not limited to a particular presentation format or method.

Display of enhancements employs computer program code operating in receiving units 108 and enhancement data received from a broadcaster or content provider. During presentation of a program, an icon or other indicator may be displayed to indicate that enhanced content is available. Selection of the indicator may produce a menu of available enhancements. Selection of one of the menu entries may result in a request being issued for enhancement data and/or computer program code associated with the selected enhancement. The computer program code defines enhancement windows, overlays, or other areas for showing enhancement information and that displays associated enhancement information. The computer program code may also establish a data structure having data elements, such as sports team scores or stock quotes, for example, that are stored in memory locally in the receiving unit. The transfer of data elements to the receiving units 108 may employ transmission of enhancement data elements to individual receiving units or may employ broadcast of enhancement data elements to a plurality of receiving units, as shall be described hereinafter. The term transmission in this disclosure refers to the transfer of information to a specific receiving unit, as may be identified by serial number, address in the cable television system, or other information that uniquely identifies a receiving unit. The term broadcast in this disclosure refers to the transfer of information to a plurality of receiving units.

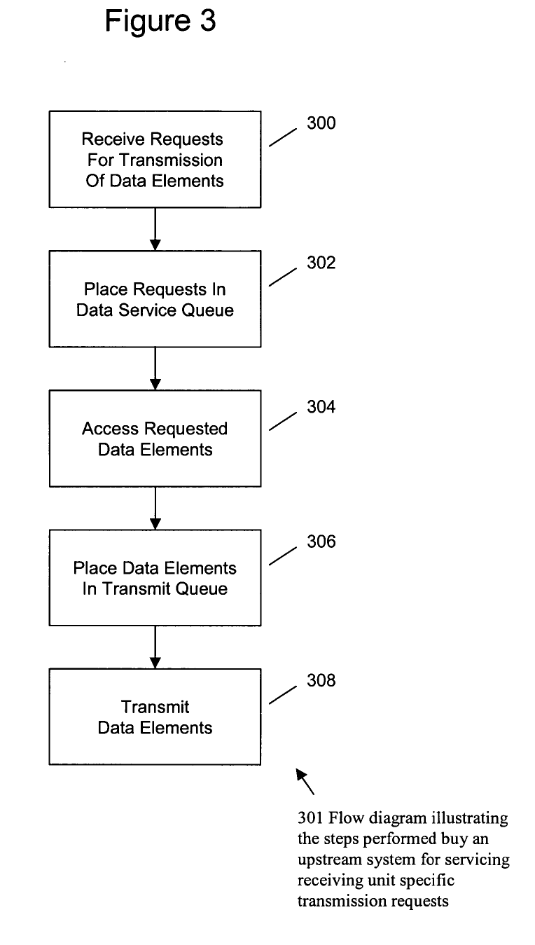

FIG. 3 is a flow diagram depicting a receiving unit specific transmission method for servicing enhancement data requests. This method is similar to Internet data transfer wherein each request received for enhancement information is processed individually by an upstream device 102, such as a headend system, for example. At step 300, requests are received from receiving units 108 for transmission of enhancement data elements. At step 302, the requests are placed in a data request service queue in the upstream device 102. At step 304, requests are processed and the requested data elements are accessed and may be formatted by the upstream device 102 to correspond to formats used by receiving units 108. Accessing data may comprise accessing a server (not shown), either locally or across a network, and retrieving data elements. At step 306, the data elements and executable code, if any, are placed in a transmit queue. Step 306 may also include formatting of data, association of the data with a requestor address and the like. At step 308, the data elements are transmitted to the requestor's receiving unit 108 at that particular receiving unit's address or other identifier in the network The method of FIG. 3 is inefficient because the server must be accessed for each request and because a message is generated and transmitted for each request made by a receiver 108, even though identical messages that contain the same data may be generated and transmitted for different receivers 108. This results in significant utilization of network bandwidth. Storing requests for a predetermined period such that requests for the same information may be serviced by a single server access may reduce the inefficiency of server access, but does not alleviate high bandwidth requirements resulting from the transmission of a message for each request.

The following figures illustrate a number of embodiments of broadcast database replication. Broadcast database replication refers to the storing of database elements in a receiving unit that replicate database elements stored in an upstream device 102 such as a headend, of a broadcaster or enhancement content provider. Broadcast database replication has the advantage of reducing the number of messages sent, or the size of messages sent, thereby reducing required system bandwidth.

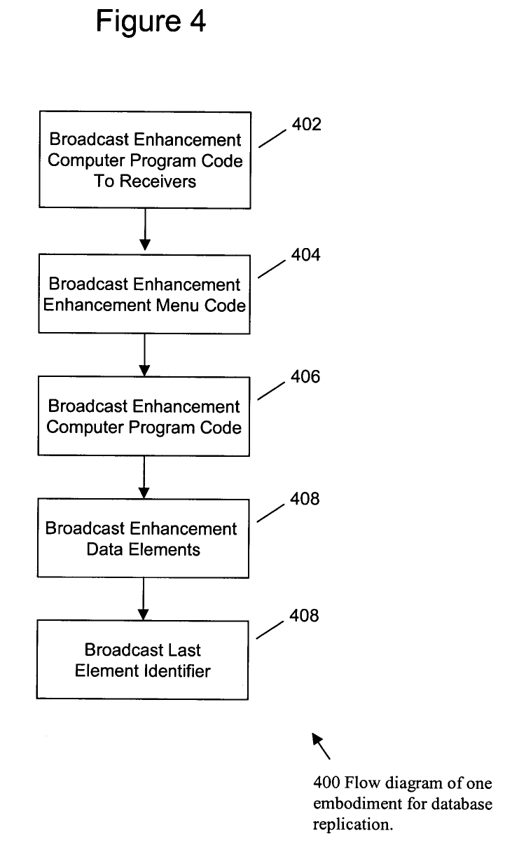

FIG. 4 is a flow diagram depicting one method for broadcast database replication. In the method of FIG. 4, enhancement computer program code is broadcast to a plurality of receivers. The enhancement computer program code may be targeted to specific receiving unit models or types and may include information that identifies such. The enhancement computer program code may display an icon or other indicator indicating that enhanced content is available. Enhancements may be turned on or off by a viewer.

In one embodiment, enhancement computer program code, enhancement menu code, enhancement processing code, and enhancement data elements are broadcast to a plurality of receivers. The enhancement data elements may provide data for one enhancement or a plurality of enhancements. The receiver displays an enhancement menu, and displays data elements associated with a selected enhancement using the enhancement processing code. The enhancement processing code can display data from one or more selected enhancements. Data elements for all enhancements are broadcast. Data elements may be stored or may be selectively stored depending upon selected enhancements. This embodiment provides simple broadcast management since only one version of enhancement processing code is broadcast.

In another embodiment, the enhancement computer code displays an indicator to indicate that enhanced content is available to the viewer. Upon response from a viewer, which may comprise selecting an icon, activating a remote control button or other otherwise responding to the indicator, the enhancement code configures the receiver to detect and acquire data corresponding to a predefined identifier. An identifier may be an MPEG packet header, predefined line during the VBI (vertical blanking interval), or may employ any other method of identifying data including but not limited to those defined by ATVEF (Advanced Television Enhancement Forum). Acquired data may comprise menu code that displays a menu of available enhancement options. Alternatively, the menu code may be provided as part of the enhancement computer program code broadcast to a plurality of receiving units. Upon selection of an enhancement option, the code configures the receiver to detect and acquire data corresponding to the selected enhancement using a corresponding identifier. Acquired data may provide enhancement processing code that defines a data structure for storage of enhancement information and that may also define the manner in which enhancement information is presented. The processing code may further configure the receiver to detect and acquire data elements of the selected enhancement. Alternatively, the processing code and data elements may be acquired using the same identifier and may be stored and utilized according to the enhancement computer program code. Data elements are detected and acquired and may add to or replace data elements already stored. Further, data elements may serve as links to additional enhancements. For example, selecting a displayed element, such as a sports event score, may provide game statistics or other information. A remote control or other input device may be employed to select displayed elements and to navigate to a previous mode of display. The broadcast stream may contain enhancement data for a plurality of different enhancements where data for each different enhancement employs a different identifier or range of identifiers. By broadcasting enhancement computer program code and a plurality of different enhancement data types, receivers may navigate among and process the various enhancements without using upstream communication. The advantage of this method is that enhancements may be provided to a large number of receivers without using bandwidth to communicate with individual receivers. Referring to FIG. 4, flow diagram 400 starts at step 402 where enhancement computer program code is broadcast to a plurality of receiving units. At step 404, enhancement menu code is broadcast. At step 406, enhancement processing computer program code is broadcast. A single version of enhancement processing code may be broadcast or multiple versions may be broadcast wherein each version contains an identifier. At step 406, enhancement data elements accessed from an upstream device 102 or other broadcaster/content provider database and are broadcast to receivers 108. Data elements may contain an identifier associating the element(s) with an enhancement. At step 408, an optional last data element indicator or end of service indicator may be broadcast. As noted above, steps 402 and 404 may be combined such that enhancement computer program code and enhancement menu code are broadcast in one step. The method of claim 4 is well suited to providing enhancement information in conjunction with the broadcast of sporting events. By broadcasting a predefined set of enhancements and providing computer program code to receivers to navigate among enhancement options, upstream communication is not used and equipment requirements for processing user requests may be reduced. The method of FIG. 4 also allows preloading of enhancement data such that scores for a plurality of teams may be broadcast and stored in the receiver and then may be viewed later. This alleviates situations that may occur in request based enhancement servicing where a surge of requests may occur at times, such as the beginning of half-time, for example where may thousands of requests may be received requesting league scores. The method of FIG. 4 provides efficient use of available bandwidth but is limited to predefined enhancement content and does not provide for viewer request of a wider range of enhancement information.

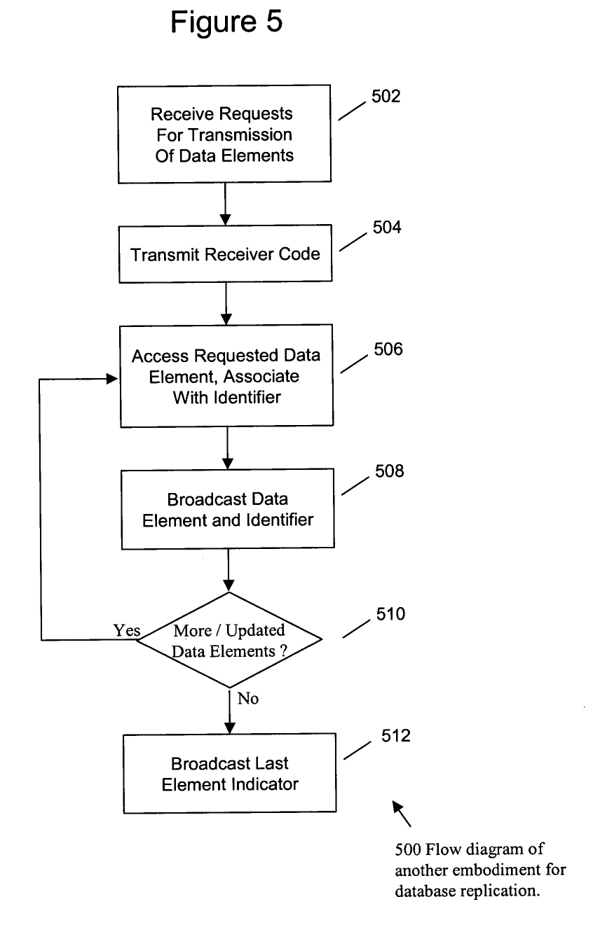

FIG. 5 is a flow diagram depicting a second method for broadcast database replication. The method illustrated in FIG. 5 is similar to that shown in FIG. 4 but employs viewer requests to select a portion of the enhancements presented. In one embodiment, viewer requests may be employed to limit broadcast bandwidth employed for enhancement information to that used for requested elements only. In another embodiment, the broadcast may have both predefined content (as disclosed in FIG. 4) and viewer requested content. At step 502, requests are received by upstream device 102 from receivers 108 for transmission of data elements. At step 504, enhancement processing code that defines a data structure, controls display of enhancement information, and that provides one or more identifiers for broadcast data elements to be stored may be transmitted to the receiving unit. Alternatively, the processing code may be resident in the receiving unit and may have been downloaded at power-up of the unit or in response to a request to display enhancement options. At step 506, one or more data element(s) corresponding to the viewer request is accessed from a database in the upstream device 102 or other broadcaster/content provider and is associated with an identifier. At step 508, the data element(s) and identifier are broadcast. At step 510, a check is performed to determine if there are requested elements in the database that have not been broadcast or if there are updated database elements. If there are additional or updated database elements, processing continues at step 506 where the additional or updated element(s) are accessed and are then broadcast at step 508. The check performed at step 510 may employ delays or predefined time intervals, such as stock quotes being updated at some interval, and such as providing game scores until as final score for a last game in a group of games is received. Once all requested elements have been broadcast and there are no updated elements, processing continues at step 512 where an optional last data element indicator or end of service indicator may be broadcast.

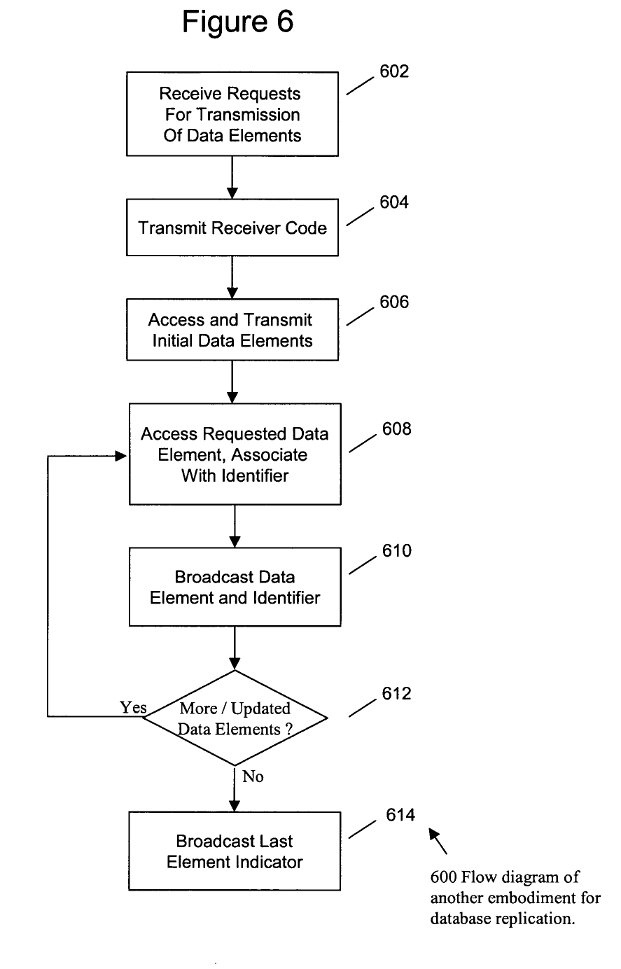

FIG. 6 is a flow diagram depicting another method for database replication. The method shown in FIG. 6 is similar to that of FIG. 5 but provides transmission of an initial set of data elements. In the method of FIG. 6, requests for enhancement information are serviced by first transmitting an initial set of data elements to each requester (receiving unit) and then by broadcasting updated or additional data elements to a plurality of receiving units. This method may be employed to provide a receiving unit with an initial set of data elements, such as current game scores or stock quotes, for example, and then providing broadcast updates to a plurality of receiving units as scores or stock values change. At step 602, requests are received for transmission of data elements. The request may be issued by a receiving unit 108 in response to a user input, such as selection of an enhancement icon, for example. Data elements may comprise game show play at home information, sports event scores, stock quotes, or other information associated with interactive systems. At step 604, enhancement processing program code may be transmitted to the receiving unit. The enhancement processing code controls the display of enhancement information and contains a data structure for storing data elements. The processing program code also specifies one or more data element identifiers with which the receiving unit monitors a broadcast stream and identifies data elements that are in the broadcast stream that are added to or replace data elements in the data structure. Alternatively, the processing program code may be resident in the receiving unit and may have been downloaded at power-up of the unit or in response to a request to display enhancement options. At step 606, one or more data element(s) corresponding to the viewer request is accessed from a database in the upstream device 102 or other broadcaster/content provider and is transmitted to the requesting receiver 108. The receiving unit stores the transmitted data in the data structure and displays the data according to the processing code. At step 608, one or more data element(s) corresponding to the viewer request is accessed from a database in the upstream device 102 or other broadcaster/content provider and is associated with an identifier. At step 610, the data element(s) and identifier are broadcast to a plurality of receivers. At step 612, a check is performed to determine if there are requested elements in the database that have not been broadcast or if there are updated database elements. If there are additional or updated database elements, processing continues at step 608 where the additional or updated element(s) are accessed and are then broadcast at step 610. The check performed at step 612 may employ delays or predefined time intervals, such as stock quotes being updated at predetermined intervals, and such as providing game scores until as final score for a last game in a group of games is received. Once all requested elements have been broadcast and there are no updated elements, processing continues at step 614 where an optional last data element or end of service indicator may be broadcast. Alternatively, the method of FIG. 6 may be employed without step 614 such that after some period of time, there are no new or additional data elements and no further elements are broadcast.

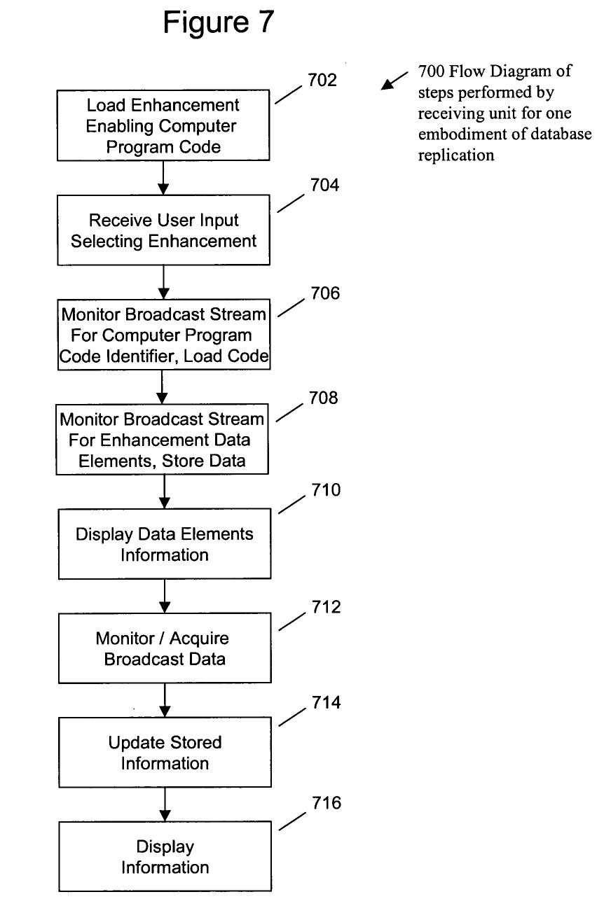

FIG. 7 is a flow diagram depicting the steps performed by a receiving unit 108 for one embodiment of broadcast database replication. At step 702, enhancement computer program code is loaded to the receiving unit. The enhancement computer program code can produce an indicator, such as an on-screen icon, for example, if enhanced content is available, and can display a menu of enhancement selections in response to a user input. At step 704 a user input is received selecting an enhancement. At step 706, the receiving unit listens to a broadcast stream for data with a predetermined identifier. At step 708, data corresponding to the predetermined identifier is detected, stored and processed by the receiving unit. Data may comprise both enhancement content and computer program code that defines a data structure in which enhancement content is stored and the manner in which it is presented. At step 710, enhancement data is displayed. At step 712, the receiving unit listens for data with the predetermined identifier that provides updated or additional data elements. At step 716 the data is stored in the data structure. At step 718 enhancement data is displayed. Steps 712 to 718 may be repeated such that the receiving unit continues to listen to the broadcast stream for data that may provide additional or updated data elements that are stored in the data structure and displayed.

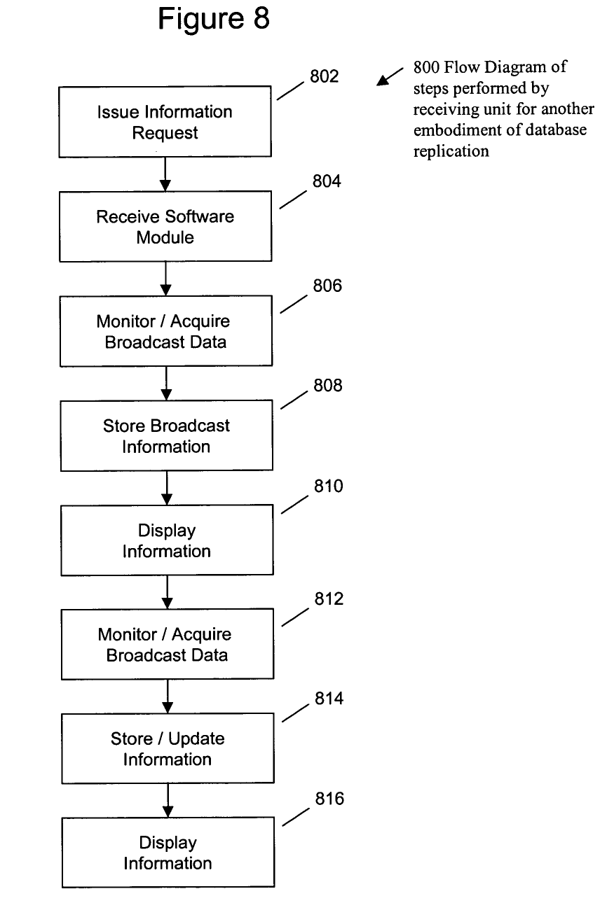

FIG. 8 is a flow diagram depicting the steps performed by a receiving unit for another method of broadcast database replication. At step 802, a receiving unit 108 issues a request for enhanced content. The request may be in response to a user input selecting an enhancement menu item, for example. At step 804, the receiving unit 108 receives computer program code or a software module. Alternatively, the code may have been previously downloaded, such as when a viewer selects an enhancement mode, for example. At step 806, the receiving unit monitors the broadcast stream for a predetermined identifier. When a corresponding identifier is detected, the receiving unit acquires the data associated with the identifier. At step 808, the data is stored in a data structure in the receiving unit memory. At step 810, the information is displayed. Such display may comprise scrolling information across the screen or other presentation methods such that not all stored information is displayed at one time. At step 812, the receiving unit continues to monitor the broadcast for the identifier. When a corresponding identifier is detected, the receiving unit acquires the data associated with the identifier. The data acquired in step 812 may comprise new information, such as scores for a sporting event that has recently begun, or a new question for a game show, or the data may comprise update information wherein values previously stored in the receiving unit memory may be replaced by the data values acquired in step 806. At step 814, the information is stored in the data structure. At step 816, the information is displayed. Steps 812-816 may be repeated and updated or additional data elements may be stored and displayed.

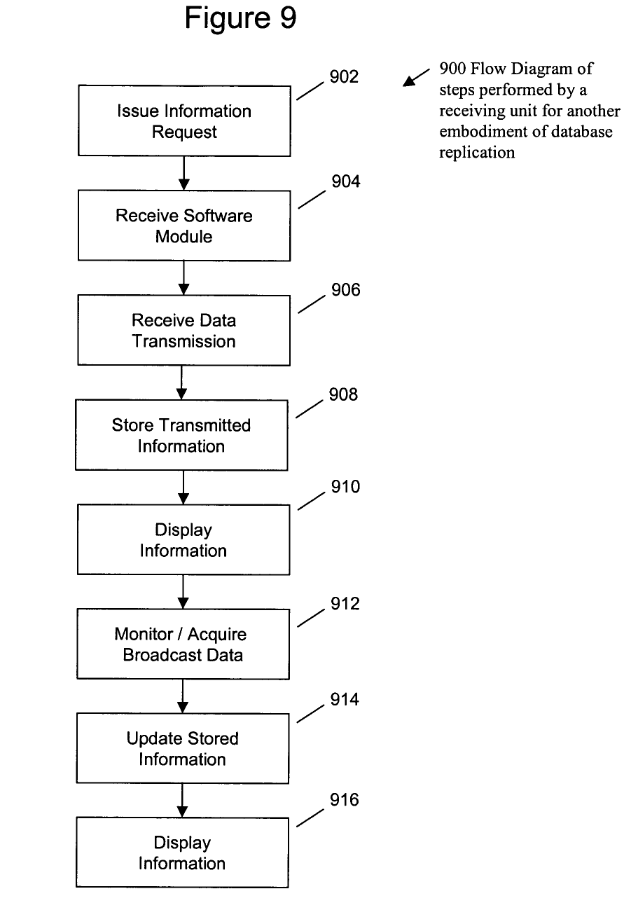

FIG. 9 is a flow diagram depicting steps performed by a receiving unit for another embodiment of broadcast database replication. The method of FIG. 9 employs transmission of an initial set of data elements to the receiving unit and update and/or addition to the data elements through broadcast data. At step 902, the receiving unit issues a request for enhanced content. The request may be in response to a user input selecting an enhancement menu item, for example. At step 904, the receiving unit receives transmitted computer program code. Alternatively, the code may have been previously downloaded, such as when a viewer selects an enhancement mode, for example. At step 906, the receiving unit receives one or more transmitted data elements. At step 908, the data received in step 906 is stored in the receiving unit in a data structure. At step 910, the stored enhancement information may is displayed. At step 912, the receiving unit monitors the broadcast for a predefined identifier. As previously noted, the identifier may comprise a predetermined range of values and broadcast may comprise MPEG data, data contained within the VBI, or data broadcast in other formats including ATVEF compliant formats. When a corresponding identifier is detected, the receiving unit acquires the data associated with the identifier. At step 914, the data is stored in the data structure. The data may comprise new information, such as scores for a sporting event that has recently begun, or a new question for a game show, or the data may comprise update information wherein values previously stored in the receiving unit memory may be replaced by the data values acquired in step 912. At step 916, information is displayed. Again, such display may comprise a scrolling display format, or other format, such that all information stored in the receiving unit may not be presented at one time. Further, the display of information may be controlled in response to viewer input such that the receiving unit may acquire and update stored information as it is broadcast, but only display the information at times determined by the viewer. For example, the viewer may select an enhancement wherein sports scores are acquired and then display the scores only part of the time. Viewers may select this method of enhancement display to view a sports event in “full screen” during play and then may elect to display scores from other games at times such as during commercial messages or when play is paused, for example.

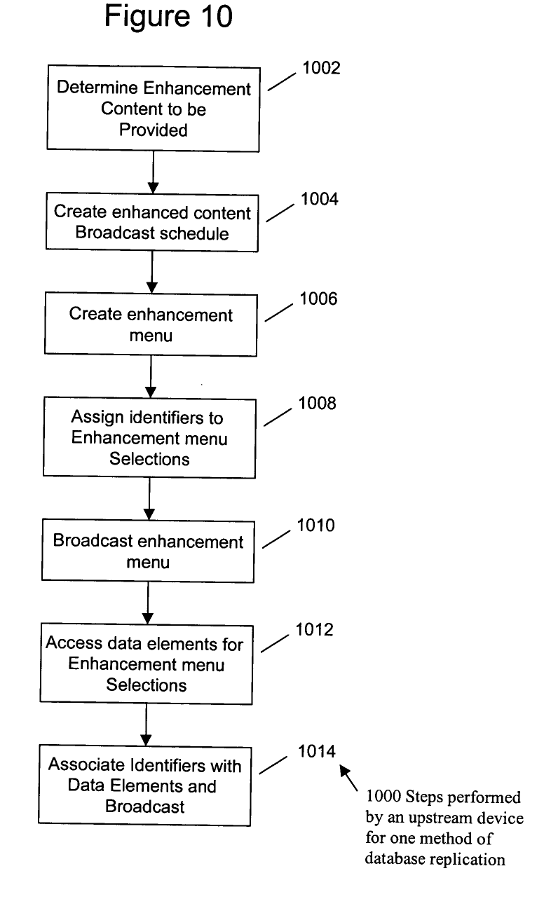

FIG. 10 is a flow diagram depicting steps performed at an upstream device to implement one embodiment of broadcast database replication. At step 1002, enhancement content to be provided is determined and is categorized by type. Determination of enhanced content to be provided may reflect program viewership, revenues generated, available data, or other factors. Enhancement data types may include synchronous, asynchronous, static, and dynamic. Synchronous data types correspond to timed or regularly occurring events, such as game show or other enhancements provided in synchrony with a program. Asynchronous data types correspond to events that do not occur at regular intervals, such as a change in score for a sports contest, for example. Static data types correspond to unchanging values, such as scores for last week's games, for example. Dynamic data types change over time and may be provided or updated at predefined intervals, such as stock prices or temperature for example. At step 1004, an enhanced content broadcast schedule is created. Schedule creation may employ variables such as available bandwidth, enhancement type, and enhancement data size to produce a broadcast queue. Enhancement data may be prioritized and the priority may reflect program popularity, the number of requests or other metrics. Synchronous events and data elements updated at a predetermined interval occupy regular positions in the queue with asynchronous and static data elements being inserted into the queue on a space available basis. At step 1006, and enhancement menu is created that lists the enhancements schedule in the broadcast queue. At step 1008 identifiers are assigned to enhancement menu selections. More than one type of data element or enhancement selection may employ the same identifier and the receiving unit computer program code can be used to further select and display enhancement data elements. At step 1010 the enhancement menu is broadcast. This broadcast may also include computer program code that enables a receiving unit to display an enhancement menu, acquire data using an identifier associated with a selected menu item or items, and display a portion of the acquired data. At step 1012, values for data elements of the enhancement selections are accessed. At step 1014, identifiers are assigned to the data elements and are broadcast employing the broadcast queue. The broadcast schedule is dynamic and reflects both the availability of data elements (such as score changes, for example) and the priority of enhancements provided.

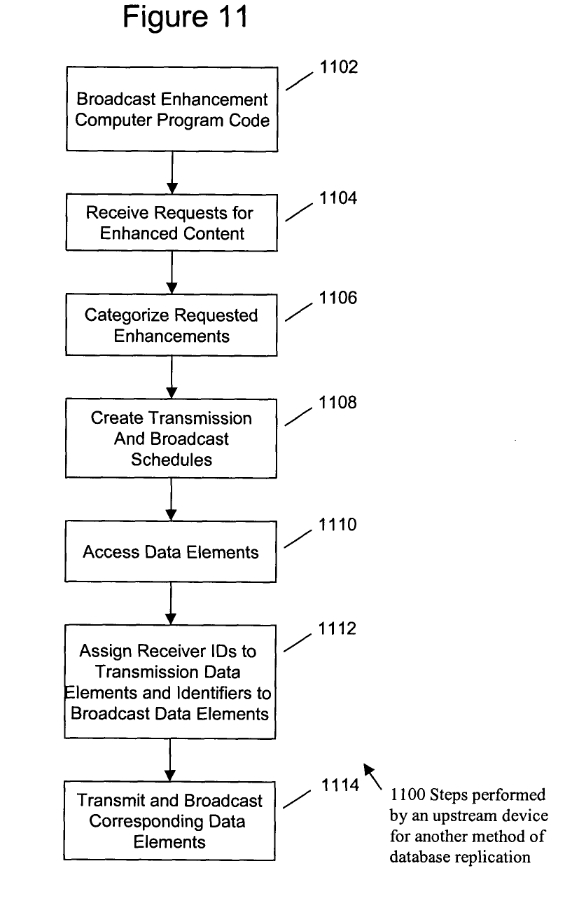

FIG. 11 is a flow diagram is a flow diagram depicting steps performed at an upstream device to implement another embodiment of broadcast database replication. At step 1102, enhancement computer program code is broadcast to a plurality of receivers 108. The code may include a database structure, a menu of available enhancements, identifiers associated with menu items, and code that processes and displays data elements acquired from a broadcast stream. At step 1104, requests from receivers 108 for enhanced content are received at upstream device 102. At step 1106, requested enhancements are categorized by type and by frequency of request. Types include those disclosed in FIG. 10 and also include whether an initial data set is to be transmitted. At step 1108, an enhanced content transmission schedule and an enhanced content broadcast schedule are created. Transmission refers to the transfer of data elements to individual receivers while broadcast refers to the transfer of data elements to a plurality of receivers. The schedules may reflect the enhancement data type, priority, data size and availability of data. Availability of data includes if data values have changed (such as game scores), if sports contests have started, if stock markets are closed and the like. At step 1110, data elements corresponding to the enhancements in the transmission and broadcast schedules are accessed. At step 1112, receiver IDs are assigned to transmission schedule data elements and identifiers are assigned to broadcast schedule data elements. At step 1114 receiver IDs and corresponding data elements are transmitted and identifiers and corresponding data elements are broadcast.

Transfer of data elements to a receiving unit may include information describing a position in a data structure where the element is to be stored. Alternatively, computer program code operating in the receiver may compare data elements acquired from the broadcast stream with data elements stored in memory and may replace or add data elements to the data structure. Data elements may also be “hot” in that a link, identifier, or executable code is associated with the displayed element and selection of the displayed element with a remote control, mouse, or other input device activates the link or code or results in data associated with the identifier being acquired and processed. For example, referring again to FIG. 2, a user may select displayed temperature 205 and the selection may result in the display of a weather forecast. Similarly, a user may select a displayed team score and game statistics, schedules, or other information may then be displayed. Further, selection of a displayed item may produce display of a menu of options such that the user may navigate through available options. Multiple links may be provided and a user may select among links. Hot data elements may also provide advertising. The manner in which linked information is transferred and displayed may employ any of the methods disclosed above. Linked information may also be “hot”, providing a hierarchy of additional information. The code employed to display linked information may be previously downloaded to a receiver as part of enhancement computer program code, or may be downloaded when linked information is selected. The transfer of linked information and associated code, if any, may employ transmission to specific receiving units, or may employ broadcast to a plurality of units wherein an identifier or identifiers as described above may be employed. Executable code may be associated with an identifier or data element. The function of the code is not limited in scope. For example, code associated with an identifier or data element may indicate that a particular data set is complete, such as may be the case for the end of a game show, and may display top scores for at-home players. Executable code may also display advertising, pop-ups, logos, etc.

The present invention provides increased bandwidth efficiency because the receiving unit does not need to submit a request for updated information. Further bandwidth efficiency is obtained through the broadcast of data elements such that a plurality of receiving units acquire the database information through a single broadcast in contrast transmitting data elements to each receiving unit individually. As such, the present invention provides a valuable new method for replicating a portion of an enhancement database at a receiving unit and for displaying structured data enhancements to viewers. References made herein to the ATVEF specification are made for illustrative purposes only, and such references should not be construed as an endorsement, in any manner, of the ATVEF specification.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of transferring data elements of a data structure to a receiving unit in a broadcast video system comprising:
broadcasting enhancement computer program code to a plurality of receiving units including said receiving unit wherein said code defines a data structure within a memory of said receiving units, provides a menu having a plurality of enhancement selections, associates an identifier with at least one enhancement selection of said plurality of enhancement selections, and enables said receiving unit to acquire data using said identifier;
accessing a plurality of data elements such that at least one data element corresponds to said at least one enhancement selection;
associating said identifier with said at least one data element;
broadcasting said at least one data element and said identifier to said plurality of receiving units including said receiving unit;
accessing a second data element corresponding to said at least one enhancement;
associating said identifier with said second data element; and
broadcasting said second data element and said identifier to said plurality of receiving units including said receiving unit.

2. The method of claim 1 further comprising:
accessing a third data element the corresponds to another enhancement selection of said plurality of enhancement selections;
associating another identifier with said third data element; and
broadcasting said third data element and said identifier to said plurality of receiving units including said receiving unit.

3. The method of claim 1 wherein said second data element replaces said first data element in said data structure in said receiver.

4. The method of claim 1 further comprising:
broadcasting computer program code associated with said at least one enhancement selection to said plurality of receiving units including said receiving unit that detects and acquires data associated with said identifier and that stores said data in a memory of said receiving unit.

5. The method of claim 1 further comprising:
associating a link with said at least one data element wherein said link is activated if the display of said at least one data element is selected by a user.

6. The method of claim 1 further comprising:
associating executable program code with said at least one data element wherein said code is executed if the display of said at least one data element is selected by a user.

7. The method of claim 1 further comprising:
receiving a request from said receiving unit for said one enhancement selection of said plurality of enhancement selections.

8. The method of claim 7 further comprising:
transmitting computer program code associated with said at least one enhancement selection to said receiving unit that detects and acquires data associated with said identifier and that stores said data in a memory of said receiving unit.

9. The method of claim 7 further comprising:
associating a link with said at least one data element wherein said link is activated if the display of said at least one data element is selected by a user.

10. The method of claim 7 further comprising:
associating executable program code with said at least one data element wherein said code is executed if the display of said at least one data element is selected by a user.

11. The method of claim 7 further comprising:
accessing a first data element that corresponds to said at least one enhancement selection;
transmitting said first data element to said receiver.

12. The method of claim 11 wherein said step of transmitting further comprises:
transmitting said first data element addressed to said receiving unit prior to broadcasting said least one data element and said identifier to said plurality of receiving units including said receiving unit.

13. A method of replicating a portion of a data structure stored in an upstream device of a broadcast system in a receiving unit of said broadcast system and displaying an element of said data structure at said receiving unit comprising:
receiving a broadcast at said receiving unit that includes enhancement computer program code that defines at least one data structure and that provides a menu having a plurality of different enhancement selections and that associates an identifier with at least one enhancement selection of said plurality of different enhancement selections and that enables said receiving unit to acquire data associated with said identifier;
receiving a user input selecting said at least one enhancement selection from said menu;
monitoring a broadcast for said identifier;
acquiring a data element associated with said identifier;
storing said data element in said data structure in a memory of said receiving unit; and
displaying said data element.

14. The method of claim 13 further comprising:
monitoring said broadcast for said identifier;
acquiring enhancement processing program code associated with said identifier; and
displaying said data element in accordance with said enhancement processing program code.

15. The method of claim 13 further comprising:
receiving a user input selecting the display of said data element; and
activating a link associated with said data element if said link exists.

16. The method of claim 13 further comprising:
receiving a user input selecting the display of said data element; and
executing computer program code associated with said data element if said code exists.

17. The method of claim 13 further comprising:
receiving a user input selecting the display of said data element; and
acquiring and processing data using a second identifier associated with said data element if said second identifier exists.

18. The method of claim 13 further comprising:
issuing a request to an upstream device for said at least one enhancement selection.

19. The method of claim 18 further comprising:
receiving a transmission at said receiving unit that contains a first data element; and
storing said first data element in said data structure.

20. The method of claim 18 further comprising:
receiving a user input selecting the display of said data element; and
activating a link associated with said data element if said link exists.

21. The method of claim 18 further comprising:
receiving a user input selecting the display of said data element; and
executing computer program code associated with said data element if said code exists.

22. The method of claim 18 further comprising:
receiving a user input selecting the display of said data element; and
acquiring and processing data using a second identifier associated with said data element if said second identifier exists.

23. The method of claim 13 wherein said data element further comprises:
an indicator that no additional data elements associated with said request remain to be broadcast.

24. A receiving unit that replicates a portion of a broadcast data structure comprising:
a CPU;
a memory;
video hardware that produces an on-screen display of enhancement data elements; and
computer program code stored in said memory that defines a data structure and an enhancement menu having at least one enhancement selection associated with an identifier and that monitors a broadcast for said identifier and acquires and stores a data element associated with said identifier in said data structure, and displays said data element, if a user selects said at least one enhancement selection.

25. The method of claim 24 wherein said computer program code further comprises:
code that issue a request to an upstream device for enhancement data associated with said at least one enhancement selection in response to a user input selecting said at least one enhancement selection.

26. The system of claim 25 further comprising:
program code that receives a transmitted data element and that stores said transmitted data element in said data structure in said memory.

27. A method of replicating a portion of an upstream device data structure in a receiving unit comprising:
determining enhancement content to be provided;
creating an enhancement broadcast schedule;
creating an enhancement menu having a plurality of enhancement selections;
associating an identifier with at least one enhancement selection of said plurality of enhancement selections;
broadcasting said enhancement menu to a plurality of receivers;
accessing a plurality of data elements for said enhancement menu selections;
associating said identifier with at least one data element of said plurality of data elements; and
broadcasting said at least one data element and said identifier to a plurality of receiving units including said receiving unit.

28. The method of claim 25 further comprising:
receiving a request from said receiving unit for said at least one enhancement selection.

29. The method of claim 26 further comprising:
accessing a first data element associated with said at least one enhancement selection; and
transmitting said first data element to said receiving unit.

30. The method of claim 27 further comprising:
creating a transmission schedule including said first data element.
